(19) United States
(12) Patent Application Publication
(10) Pub. No.: US 2026/0301380 A1
(43) Pub. Date: Oct. 1, 2026

(54) SYNTHETIC DATA GENERATION

(71) Applicant: DIGITAL SURGERY LIMITED, London (GB)

(72) Inventors: Imanol Luengo Muntion, London (GB); Ricardo Sanchez-Matilla, London (GB); Emanuele Colleoni, Post-Lon (GB); Danail V. Stoyanov, London (GB)

(21) Appl. No.: 19/134,883

(22) PCT Filed: Dec. 1, 2023
(86) PCT No.: PCT/EP2023/084012

§ 371 Date: Jun. 2, 2025

Related U.S. Application Data
(60) Provisional application No. 63/429,786, filed on Dec. 2, 2022.
(60) Provisional application No. 63/462,733, filed on Apr. 28, 2023.

(51) Int. Cl. G06V 10/774; G06T 11/60; G06T 13/80; G06V 10/26; G06V 10/77; G06V 10/82

(52) U.S. Cl. CPC G06V 10/774; G06T 11/60; G06T 13/80; G06V 10/26; G06V 10/7715; G06V 10/82; G06T 2210/41; G06V 2201/03

(57) ABSTRACT

Examples described herein provide synthetic data generation. Aspects can include receiving one or more inputs each defining one or more conditions for synthetic data generation and applying one or more encoders to the one or more inputs to generate a shared feature space of feature representations. A generator generates synthetic data based on the feature representations of the shared feature space. A discriminator compares real data and the synthetic data to distinguish one or more differences between the real data and the synthetic data. Adversarial training can be applied using adversarial loss information based on the one or more differences to train the one or more encoders, the generator, and the discriminator to modify one or more components to more closely align the synthetic data with the one or more conditions and in a more similar distribution as the real data.

### BACKGROUND

The disclosure relates in general to computing technology and relates more particularly to computing technology for a synthetic data generation.

Computer-assisted systems, particularly computer-assisted surgery systems (CASs), rely on video data digitally captured during a surgery. Such video data can be stored and/or streamed. In some cases, the video data can be used to augment a person's physical sensing, perception, and reaction capabilities. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes, such as archival, training, post-surgery analysis, and/or patient consultation.

Where machine learning is used to support CASs, training data is needed to train various models. When a training data set is sparsely populated with few examples, the trained models may not perform as well as models trained with more robust sets of training data.

### SUMMARY

According to an aspect, a computer-implemented method is provided. The method includes receiving one or more inputs each defining one or more conditions for synthetic data generation and applying one or more encoders to the one or more inputs to generate a shared feature space of feature representations. A generator generates synthetic data based on the feature representations of the shared feature space. A discriminator compares real data and the synthetic data to distinguish one or more differences between the real data and the synthetic data. Adversarial training is applied using adversarial loss information based on the one or more differences to train the one or more encoders, the generator, and the discriminator to modify one or more components to more closely align the synthetic data with the one or more conditions and in a more similar distribution as the real data.

According to another aspect, a system includes a data store including video data associated with a surgical procedure. The system also includes a machine learning training system configured to train a generative adversarial network model to generate synthetic surgical data, combine the synthetic surgical data with real surgical data to form an enhanced training data set in the data store, and train one or more machine learning models using the enhanced training data set.

According to a further aspect, a computer program product includes a memory device having computer executable instructions stored thereon, which when executed by one or more processors cause the one or more processors to perform a plurality of operations. The operations include applying one or more encoders to one or more inputs associated with surgical data to generate a shared feature space of feature representations and generating, by a generator, synthetic data based on the feature representations of the shared feature space, where the generator includes a decoder with sequentially nested blocks of normalization layers including at least one pixel-level normalization block and at least one channel-level normalization block.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the invention are apparent from the following detailed description taken in conjunction with the accompanying drawings in which:

FIG. 1 depicts a computer-assisted surgery (CAS) system according to one or more aspects;

FIG. 2 depicts a surgical procedure system according to one or more aspects;

FIG. 3 depicts a system for analyzing video captured by a video recording system according to one or more aspects;

FIG. 4 depicts a block diagram of a synthetic image generator according to one or more aspects;

FIG. 5 depicts a block diagram of a synthetic image generator according to one or more aspects;

FIG. 6 depicts a block diagram of a synthetic video generator according to one or more aspects;

FIG. 7 depicts a block diagram of a synthetic image generator according to one or more aspects;

FIG. 8 depicts a block diagram of a discriminator architecture according to one or more aspects;

FIG. 9 depicts examples of synthetic images according to one or more aspects;

FIGS. 10A and 10B depict examples of synthetic image comparisons according to one or more aspects;

FIG. 11 depicts example results of segmentation model performance according to one or more aspects;

FIG. 12 depict an example of synthetic video generation applied to a simulation video according to one or more aspects;

FIG. 13 depicts a flowchart of a method of synthetic data generation according to one or more aspects; and

FIG. 14 depicts a block diagram of a computer system according to one or more aspects.

The diagrams depicted herein are illustrative. There can be many variations to the diagrams and/or the operations described herein without departing from the spirit of the invention. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Exemplary aspects of the technical solutions described herein include systems and methods for a synthetic data generation. Training Machine Learning (ML) models that are accurate, robust, and can be used for informing users, such as surgeons, typically requires of large amounts of annotated data. However, the availability of images, such as surgical images, can be limited; and annotating surgical data typically requires experts with clinical knowledge. Manual annotations can be time consuming and prone to errors. In addition, when fine-grained annotations are desired, the process can become even more complicated. To annotate large amounts of data, annotation can be externalized, which may be complicated or even unfeasible where the process could compromise protected health information of patients under some privacy regulations.

Aspects as further described herein include a framework that can generate synthetic surgical data, such as images or video, conditioned on inputs. The generated synthetic data can appear both realistic and diverse. As synthetic data is generated from the input, the input can be used as annotation, avoiding annotation problems associated with separate annotation generation. The synthetic data together with the input can be used to train machine learning models for downstream tasks, such as semantic segmentation, surgical phase, and text-to-image generation.

A lack of large datasets and high-quality annotated data can limit the development of accurate and robust machine-learning models within medical and surgical domains. Generative models can produce novel and diverse synthetic images that closely resemble reality while controlling content with various types of annotations. However, generative models have not been yet fully explored in the surgical domain, partially due to the lack of large datasets and specific challenges present in the surgical domain, such as the large anatomical diversity. According to an aspect, a generative model, Surgery-Generative Adversarial Network (SuGAN), can produce synthetic images from segmentation maps. An architecture can produce surgical images with improved quality when compared to early generative models based on a combination of channel and pixel-level normalization layers that boost image quality while granting adherence to the input segmentation map. While state-of-the-art generative models can generate overfitted images, lacking diversity, or containing unrealistic artefacts such as cartooning; experiments have demonstrated that SuGAN can generate realistic and diverse surgical images in different surgical datasets, such as: cholecystectomy, partial nephrectomy, and radical prostatectomy. In addition, the use of synthetic images together with real ones can be used to improve the performance of other machine-learning models. Specifically, SuGAN can be used to generate large synthetic datasets which can be used to train different segmentation models. Results illustrate that using synthetic images can improve mean segmentation performance with respect to only using real images. For example, when considering radical prostatectomy, mean segmentation performance can be boosted by up to 5.43%. Further, a performance improvement can be larger in classes that are underrepresented in the training sets, for example, where the performance boost of specific classes reaches up to 61.6%. Other levels of improvement can be achieved in according to various aspects.

According to an aspect, SuGAN can synthesize images or video using an architecture conditioned to segmentation maps that embraces recent advances in conditional and unconditional pipelines to support the generation of multi-modal (i.e., diverse) surgical images, and to prevent overfitting, lack of diversity, and cartooning, that are often present in synthetic images generated by state-of-the-art models. Particularly, channel- and pixel-level normalization blocks can be used, where the former allow for realistic image generation and multimodality through latent space manipulation, while the latter enforces the adherence of the synthetic images to an input segmentation map.

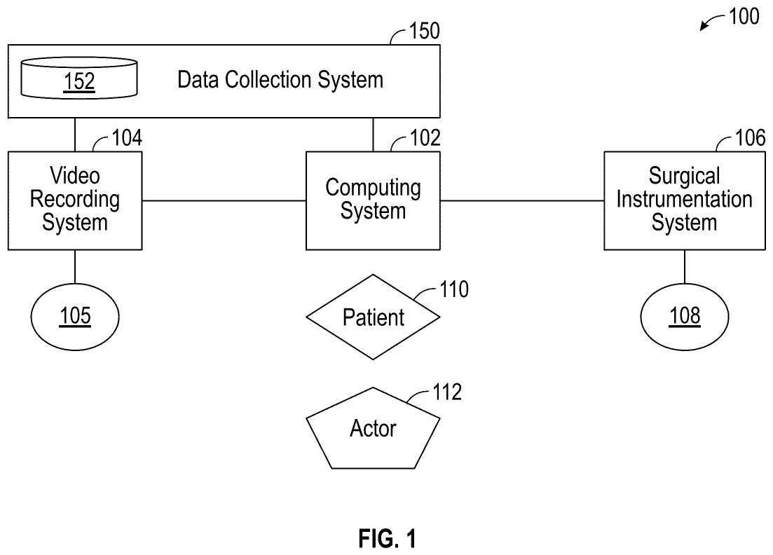

Turning now to FIG. 1, an example computer-assisted system (CAS) system 100 is generally shown in accordance with one or more aspects. The CAS system 100 includes at least a computing system 102, a video recording system 104, and a surgical instrumentation system 106. As illustrated in FIG. 1, an actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, and/or the like including combinations and/or multiples thereof.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. In addition, a particular anatomical structure of the patient may be the target of the surgical action(s).

The video recording system 104 includes one or more cameras 105, such as operating room cameras, endoscopic cameras, and/or the like including combinations and/or multiples thereof. The cameras 105 capture video data of the surgical procedure being performed. The video recording system 104 includes one or more video capture devices that can include cameras 105 placed in the surgical room to capture events surrounding (i.e., outside) the patient being operated upon. The video recording system 104 further includes cameras 105 that are passed inside (e.g., endoscopic cameras) the patient 110 to capture endoscopic data. The endoscopic data provides video and images of the surgical procedure.

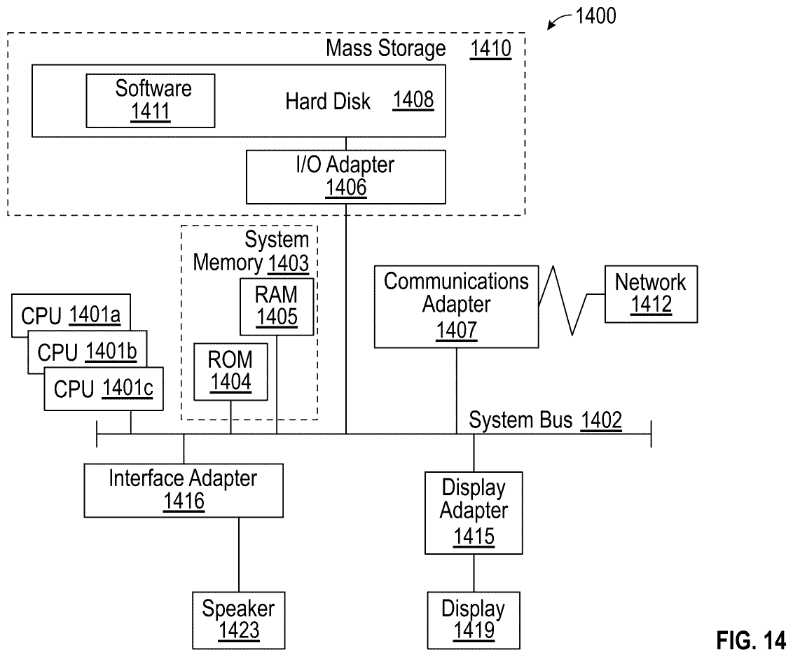

The computing system 102 includes one or more memory devices, one or more processors, a user interface device, among other components. All or a portion of the computing system 102 shown in FIG. 1 can be implemented for example, by all or a portion of computer system 1400 of FIG. 14. Computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures, such as anatomical structures, surgical instruments 108 in the captured video of the surgical procedure. Features can further include events, such as phases and/or actions in the surgical procedure. Features that are detected can further include the actor 112 and/or patient 110. Based on the detection, the computing system 102, in one or more examples, can provide recommendations for subsequent actions to be taken by the actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models use a combination of video data and surgical instrumentation data.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the various types of data captured during the surgical procedure, in an offline manner (e.g., post-surgery). In one or more examples, the machine learning models detect surgical phases based on detecting some of the features, such as the anatomical structure, surgical instruments, and/or the like including combinations and/or multiples thereof.

A data collection system 150 can be employed to store the surgical data, including the video(s) captured during the surgical procedures. The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, and/or the like including combinations and/or multiples thereof. In some examples, the data collection system can use a distributed storage, i.e., the storage devices 152 are located at different geographic locations. The storage devices 152 can include any type of electronic data storage media used for recording machine-readable data, such as semiconductor-based, magnetic-based, optical-based storage media, and/or the like including combinations and/or multiples thereof. For example, the data storage media can include flash-based solid-state drives (SSDs), magnetic-based hard disk drives, magnetic tape, optical discs, and/or the like including combinations and/or multiples thereof.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, and/or the like including combinations and/or multiples thereof), data manipulation commands (e.g., browse, copy, paste, move, delete, create, compress, and/or the like including combinations and/or multiples thereof), data manipulation results, and/or the like including combinations and/or multiples thereof. In one or more examples, the computing system 102 can manipulate the data already stored/being stored in the data collection system 150 based on outputs from the one or more machine learning models (e.g., phase detection, anatomical structure detection, surgical tool detection, and/or the like including combinations and/or multiples thereof). Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

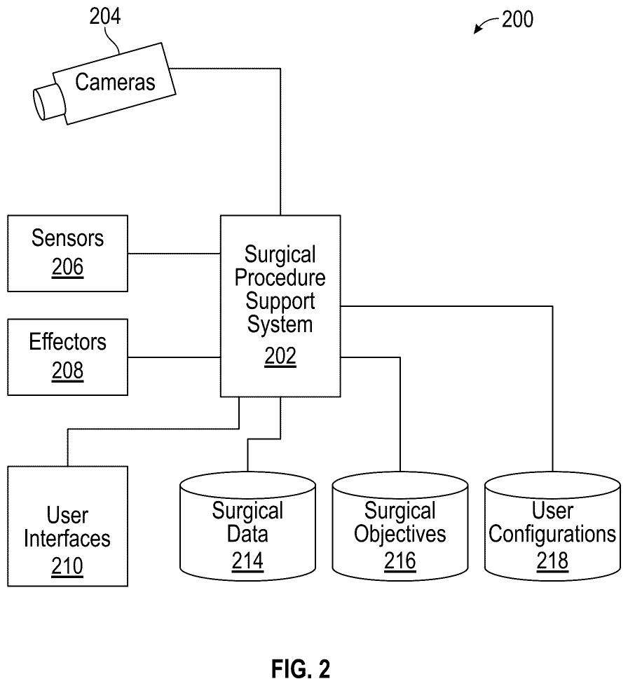

Turning now to FIG. 2, a surgical procedure system 200 is generally shown according to one or more aspects. The example of FIG. 2 depicts a surgical procedure support system 202 that can include or may be coupled to the CAS system 100 of FIG. 1. The surgical procedure support system 202 can acquire image or video data using one or more cameras 204. The surgical procedure support system 202 can also interface with one or more sensors 206 and/or one or more effectors 208. The sensors 206 may be associated with surgical support equipment and/or patient monitoring. The effectors 208 can be robotic components or other equipment controllable through the surgical procedure support system 202. The surgical procedure support system 202 can also interact with one or more user interfaces 210, such as various input and/or output devices. The surgical procedure support system 202 can store, access, and/or update surgical data 214 associated with a training dataset and/or live data as a surgical procedure is being performed on patient 110 of FIG. 1. The surgical procedure support system 202 can store, access, and/or update surgical objectives 216 to assist in training and guidance for one or more surgical procedures. User configurations 218 can track and store user preferences.

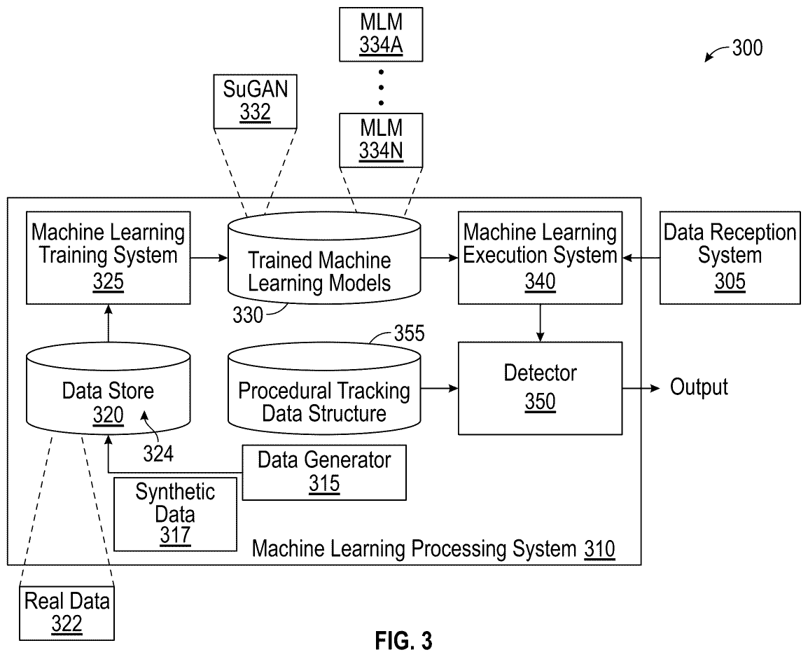

Turning now to FIG. 3, a system 300 for analyzing video and data is generally shown according to one or more aspects. In accordance with aspects, the video and data is captured from video recording system 104 of FIG. 1. The analysis can result in predicting features that include surgical phases and structures (e.g., instruments, anatomical structures, and/or the like including combinations and/or multiples thereof) in the video data using machine learning. System 300 can be the computing system 102 of FIG. 1, or a part thereof in one or more examples. System 300 uses data streams in the surgical data to identify procedural states according to some aspects.

System 300 includes a data reception system 305 that collects surgical data, including the video data and surgical instrumentation data. The data reception system 305 can include one or more devices (e.g., one or more user devices and/or servers) located within and/or associated with a surgical operating room and/or control center. The data reception system 305 can receive surgical data in real-time, i.e., as the surgical procedure is being performed. Alternatively, or in addition, the data reception system 305 can receive or access surgical data in an offline manner, for example, by accessing data that is stored in the data collection system 150 of FIG. 1.

System 300 further includes a machine learning processing system 310 that processes the surgical data using one or more machine learning models to identify one or more features, such as surgical phase, instrument, anatomical structure, and/or the like including combinations and/or multiples thereof, in the surgical data. It will be appreciated that machine learning processing system 310 can include one or more devices (e.g., one or more servers), each of which can be configured to include part or all of one or more of the depicted components of the machine learning processing system 310. In some instances, a part or all of the machine learning processing system 310 is cloud-based and/or remote from an operating room and/or physical location corresponding to a part or all of data reception system 305. It will be appreciated that several components of the machine learning processing system 310 are depicted and described herein. However, the components are just one example structure of the machine learning processing system 310, and that in other examples, the machine learning processing system 310 can be structured using a different combination of the components. Such variations in the combination of the components are encompassed by the technical solutions described herein.

The machine learning processing system 310 includes a machine learning training system 325, which can be a separate device (e.g., server) that stores its output as one or more trained machine learning models 330. The trained machine learning models 330 are accessible by a machine learning execution system 340. The machine learning execution system 340 can be separate from the machine learning training system 325 in some examples. In other words, in some aspects, devices that “train” the models are separate from devices that “infer,” i.e., perform real-time processing of surgical data using the trained machine learning models 330.

Machine learning processing system 310, in some examples, further includes a data generator 315 to generate simulated surgical data, such as a set of synthetic images and/or synthetic video as synthetic data 317, in combination with real image and video data from the video recording system 104 (e.g., real data 322), to generate trained machine learning models 330. Data generator 315 can access (read/write) a data store 320 to record data, including multiple images and/or multiple videos. The images and/or videos can include images and/or videos collected during one or more procedures (e.g., one or more surgical procedures). For example, the images and/or video may have been collected by a user device worn by the actor 112 of FIG. 1 (e.g., surgeon, surgical nurse, anesthesiologist, and/or the like including combinations and/or multiples thereof) during the surgery, a non-wearable imaging device located within an operating room, an endoscopic camera inserted inside the patient 110 of FIG. 1, and/or the like including combinations and/or multiples thereof. The data store 320 is separate from the data collection system 150 of FIG. 1 in some examples. In other examples, the data store 320 is part of the data collection system 150.

Each of the images and/or videos recorded in the data store 320 for performing training (e.g., generating the machine learning models 330) can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, and/or the like including combinations and/or multiples thereof). Further, the other data can include image-segmentation data that identifies and/or characterizes one or more objects (e.g., tools, anatomical objects, and/or the like including combinations and/or multiples thereof) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 325 can use the recorded data in the data store 320, which can include the simulated surgical data (e.g., set of synthetic images and/or synthetic video) and/or actual surgical data to generate the trained machine learning models 330. The trained machine learning models 330 can be defined based on a type of model and a set of hyperparameters (e.g., defined based on input from a client device). The trained machine learning models 330 can be configured based on a set of parameters that can be dynamically defined based on (e.g., continuous or repeated) training (i.e., learning, parameter tuning). Machine learning training system 325 can use one or more optimization algorithms to define the set of parameters to minimize or maximize one or more loss functions. The set of (learned) parameters can be stored as part of the trained machine learning models 330 using a specific data structure for a particular trained machine learning model of the trained machine learning models 330. The data structure can also include one or more non-learnable variables (e.g., hyperparameters and/or model definitions).

In some aspects, the machine learning training system 325 can train a generative adversarial network model, such as SuGAN 332, to generate synthetic surgical data, such as synthetic data 317, as part of the data generator 315. The synthetic surgical data can be combined with real surgical data (e.g., real data 322) to form an enhanced training data set 324 in the data store 320. The machine learning training system 325 can use the enhanced training data set 324 to train one or more machine learning models 334A-334N, which can be stored in the trained machine learning models 330 for further use by the machine learning execution system 340.

Machine learning execution system 340 can access the data structure(s) of the trained machine learning models 330 and accordingly configure the trained machine learning models 330 for inference (e.g., prediction, classification, and/or the like including combinations and/or multiples thereof). The trained machine learning models 330 can include, for example, a fully convolutional network adaptation, an adversarial network model, an encoder, a decoder, or other types of machine learning models. The type of the trained machine learning models 330 can be indicated in the corresponding data structures. The trained machine learning models 330 can be configured in accordance with one or more hyperparameters and the set of learned parameters.

The trained machine learning models 330, during execution, receive, as input, surgical data to be processed and subsequently generate one or more inferences according to the training. For example, the video data captured by the video recording system 104 of FIG. 1 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 305, which can include one or more devices located within an operating room where the surgical procedure is being performed. Alternatively, the data reception system 305 can include devices that are located remotely, to which the captured video data is streamed live during the performance of the surgical procedure. Alternatively, or in addition, the data reception system 305 accesses the data in an offline manner from the data collection system 150 or from any other data source (e.g., local or remote storage device).

The data reception system 305 can process the video and/or data received. The processing can include decoding when a video stream is received in an encoded format such that data for a sequence of images can be extracted and processed. The data reception system 305 can also process other types of data included in the input surgical data. For example, the surgical data can include additional data streams, such as audio data, RFID data, textual data, measurements from one or more surgical instruments/sensors, and/or the like including combinations and/or multiples thereof, that can represent stimuli/procedural states from the operating room. The data reception system 305 synchronizes the different inputs from the different devices/sensors before inputting them in the machine learning processing system 310.

The trained machine learning models 330, once trained, can analyze the input surgical data, and in one or more aspects, predict and/or characterize features (e.g., structures) included in the video data included with the surgical data. The video data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data or predicting the localization of the structures with a probabilistic heatmap. In some instances, the one or more trained machine learning models 330 include or are associated with a preprocessing or augmentation (e.g., intensity normalization, resizing, cropping, and/or the like including combinations and/or multiples thereof) that is performed prior to segmenting the video data. An output of the one or more trained machine learning models 330 can include image-segmentation or probabilistic heatmap data that indicates which (if any) of a defined set of structures are predicted within the video data, a location and/or position and/or pose of the structure(s) within the video data, and/or state of the structure(s). The location can be a set of coordinates in an image/frame in the video data. For example, the coordinates can provide a bounding box. The coordinates can provide boundaries that surround the structure(s) being predicted. The trained machine learning models 330, in one or more examples, are trained to perform higher-level predictions and tracking, such as predicting a phase of a surgical procedure and tracking one or more surgical instruments used in the surgical procedure.

While some techniques for predicting a surgical phase (“phase”) in the surgical procedure are described herein, it should be understood that any other technique for phase prediction can be used without affecting the aspects of the technical solutions described herein. In some examples, the machine learning processing system 310 includes a detector 350 that uses the trained machine learning models 330 to identify various items or states within the surgical procedure (“procedure”). The detector 350 can use a particular procedural tracking data structure 355 from a list of procedural tracking data structures. The detector 350 can select the procedural tracking data structure 355 based on the type of surgical procedure that is being performed. In one or more examples, the type of surgical procedure can be predetermined or input by actor 112. For instance, the procedural tracking data structure 355 can identify a set of potential phases that can correspond to a part of the specific type of procedure as “phase predictions”, where the detector 350 is a phase detector.

In some examples, the procedural tracking data structure 355 can be a graph that includes a set of nodes and a set of edges, with each node corresponding to a potential phase. The edges can provide directional connections between nodes that indicate (via the direction) an expected order during which the phases will be encountered throughout an iteration of the procedure. The procedural tracking data structure 355 may include one or more branching nodes that feed to multiple next nodes and/or can include one or more points of divergence and/or convergence between the nodes. In some instances, a phase indicates a procedural action (e.g., surgical action) that is being performed or has been performed and/or indicates a combination of actions that have been performed. In some instances, a phase relates to a biological state of a patient undergoing a surgical procedure. For example, the biological state can indicate a complication (e.g., blood clots, clogged arteries/veins, and/or the like including combinations and/or multiples thereof), pre-condition (e.g., lesions, polyps, and/or the like including combinations and/or multiples thereof). In some examples, the trained machine learning models 330 are trained to detect an “abnormal condition,” such as hemorrhaging, arrhythmias, blood vessel abnormality, and/or the like including combinations and/or multiples thereof.

Each node within the procedural tracking data structure 355 can identify one or more characteristics of the phase corresponding to that node. The characteristics can include visual characteristics. In some instances, the node identifies one or more tools that are typically in use or available for use (e.g., on a tool tray) during the phase. The node also identifies one or more roles of people who are typically performing a surgical task, a typical type of movement (e.g., of a hand or tool), and/or the like including combinations and/or multiples thereof. Thus, detector 350 can use the segmented data generated by machine learning execution system 340 that indicates the presence and/or characteristics of particular objects within a field of view to identify an estimated node to which the real image data corresponds. Identification of the node (i.e., phase) can further be based upon previously detected phases for a given procedural iteration and/or other detected input (e.g., verbal audio data that includes person-to-person requests or comments, explicit identifications of a current or past phase, information requests, and/or the like including combinations and/or multiples thereof).

The detector 350 can output predictions, such as a phase prediction associated with a portion of the video data that is analyzed by the machine learning processing system 310. The phase prediction is associated with the portion of the video data by identifying a start time and an end time of the portion of the video that is analyzed by the machine learning execution system 340. The phase prediction that is output can include segments of the video where each segment corresponds to and includes an identity of a surgical phase as detected by the detector 350 based on the output of the machine learning execution system 340. Further, the phase prediction, in one or more examples, can include additional data dimensions, such as, but not limited to, identities of the structures (e.g., instrument, anatomy, and/or the like including combinations and/or multiples thereof) that are identified by the machine learning execution system 340 in the portion of the video that is analyzed. The phase prediction can also include a confidence score of the prediction. Other examples can include various other types of information in the phase prediction that is output. Further, other types of outputs of the detector 350 can include state information or other information used to generate audio output, visual output, and/or commands. For instance, the output can trigger an alert, an augmented visualization, identify a predicted current condition, identify a predicted future condition, command control of equipment, and/or result in other such data/commands being transmitted to a support system component, e.g., through surgical procedure support system 202 of FIG. 2.

It should be noted that although some of the drawings depict endoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room (e.g., surgeon). Alternatively, or in addition, the cameras can be mounted on surgical instruments, walls, or other locations in the operating room. Alternatively, or in addition, the video can be images captured by other imaging modalities, such as ultrasound.

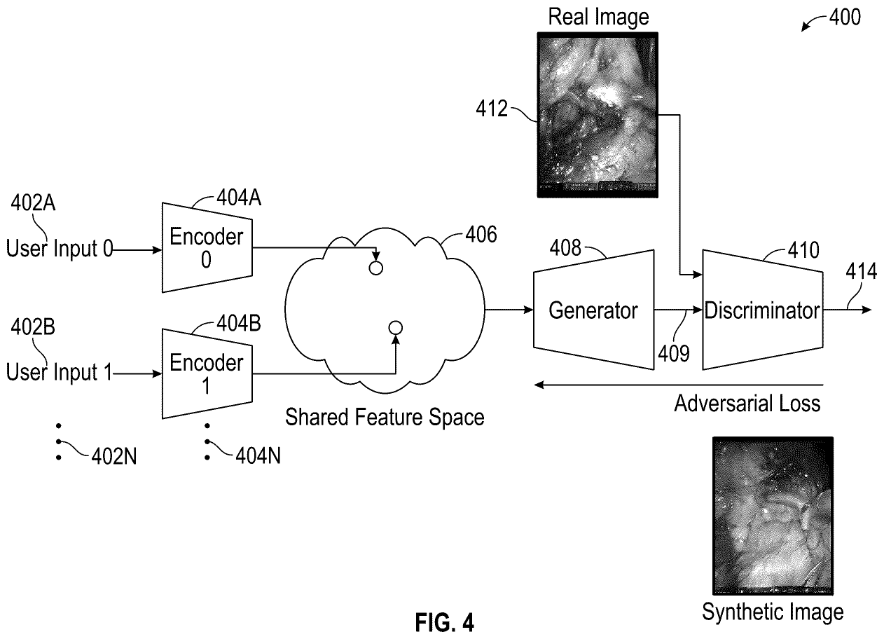

Turning now to FIG. 4, a block diagram of a synthetic image generator 400 is depicted according to one or more aspects. The synthetic image generator 400 can be part of the data generator 315 of FIG. 3. The synthetic image generator 400 includes one or more encoders 404A, 404B, . . . , 404N configured to be applied to one or more inputs 402A, 402B, . . . , 402N to generate a shared feature space 406 of feature representations. The inputs 402A-402N can be user inputs that define one or more conditions for synthetic data generation. A generator 408 can generate synthetic data 409 based on the feature representations of the shared feature space 406. A discriminator 410 can compare real data 412 (e.g., a real image) and the synthetic data 409 (e.g., a synthetic image) to distinguish one or more differences between the real data 412 and the synthetic data 409. The discriminator 410 can output logits 414 that can be converted into probabilities indicating whether the synthetic data 409 is aligned to inputs 402A-402N (e.g., as conditional logits) and/or whether the synthetic data 409 is similar to the real data 412 (e.g., as unconditional logits) in terms of distribution. The synthetic image generator 400 is configured to apply adversarial training using adversarial loss information based on the one or more differences to train the one or more encoders 404A-404N, the generator 408, and the discriminator 410 to create the synthetic data 409 to more closely align with the real data 412. The discriminator 410 can use adversarial training in which the generator 408 and discriminator 410 compete to fool each other, which can result in realistic and diverse synthetic images. The synthetic data 409 can be stored in the data store 320 as synthetic data 317 for use by the machine learning training system 325. Annotations in the inputs can also be stored in the data store 320 to use as labels associated with the synthetic data during machine learning training.

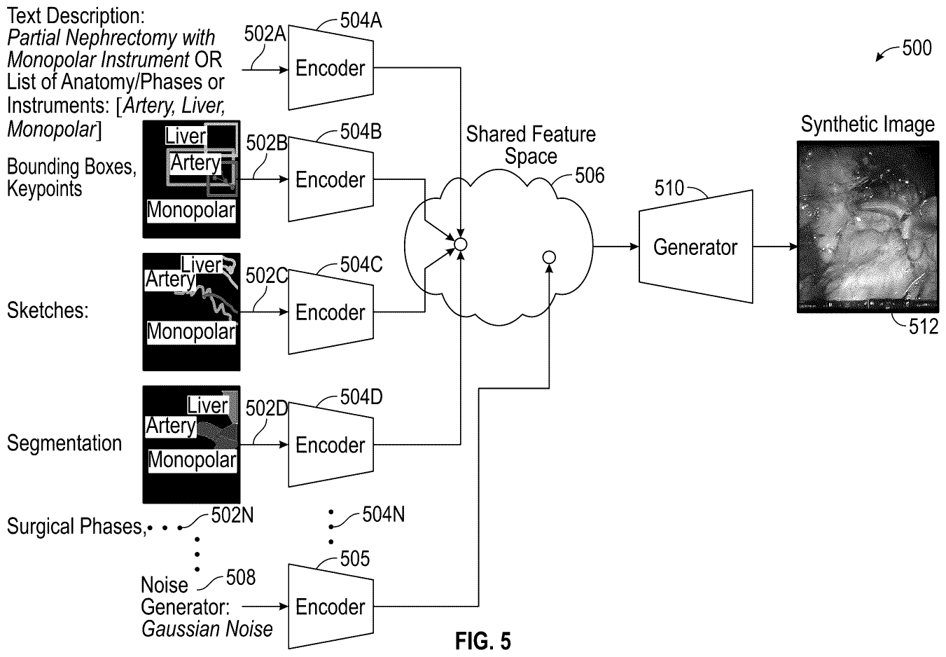

FIG. 5 depicts a block diagram of a synthetic image generator 500 according to one or more aspects. The synthetic image generator 500 is another example synthetic image generator that can be part of the data generator 315 of FIG. 3. Various types guiding can be provided in the input 502A, 502B, 502C, 502D, . . . , 502N and each encoder 504A, 504B, 504C, 504D, . . . , 504N can be trained to process particular types of input 502A-502N for mapping to a shared feature space 506. For example, text descriptions can be used to describe medical conditions, instruments, anatomy, phases, and the like in input 502A. Further, input 502B can be in the form or bounding boxes with key points and labels, sketches with labels in input 502C, segmentation regions with labels in input 502D, surgical phases in input 502N, and other such inputs 502. A noise generator 508, such as a Gaussian noise generator or other types of noise generation, can also be used to populate the shared feature space 506 as encoded by an encoder 505. An image or video generator 510 can generate a synthetic image 512 (or synthetic video) as trained to map features of the shared feature space 506 to image or video portions that are blended together. In some aspects, content can be modified in a base image and in other aspects style can be modified in a base image.

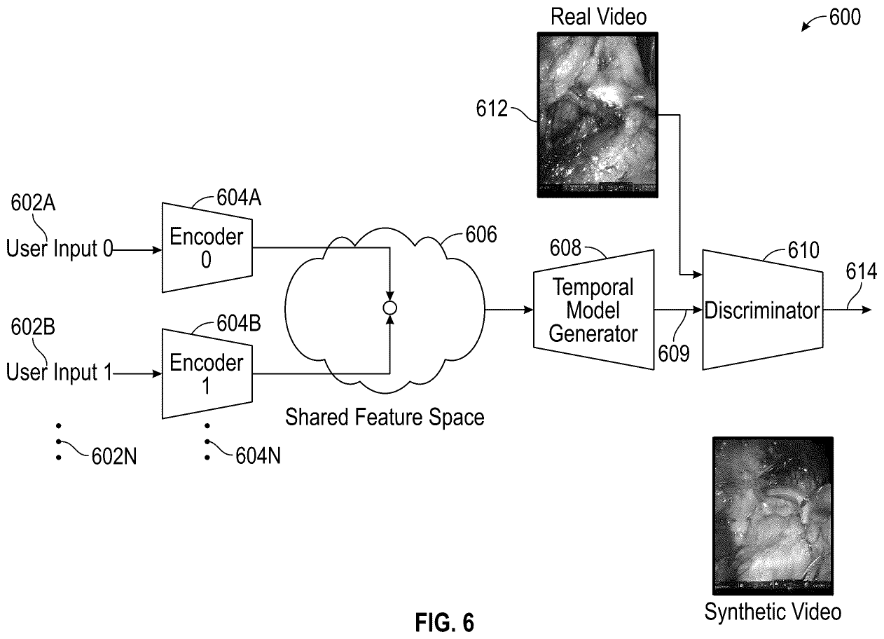

FIG. 6 depicts a block diagram of a synthetic video generator 600 according to one or more aspects. The synthetic video generator 600 can be part of the data generator 315 of FIG. 3. Similar to the example of FIG. 4, the synthetic video generator 600 can include one or more encoders 604A, 604B, . . . , 604N configured to be applied to one or more inputs 602A, 602B, . . . , 602N to generate a shared feature space 606 of feature representations. The inputs 602A-602N can be user inputs that define one or more conditions for synthetic data generation. A generator 608 can generate synthetic data 609 based on the feature representations of the shared feature space 606. A discriminator 610 can compare real data 612 (e.g., a real video) and the synthetic data 609 (e.g., a synthetic video) to distinguish one or more differences between the real data 612 and the synthetic data 609. The discriminator 610 can output logits 614 that can be converted into probabilities indicating whether the synthetic data 609 is aligned to inputs 602A-602N (e.g., as conditional logits) and/or whether the synthetic data 609 is similar to the real data 612 (e.g., as unconditional logits) with respect to distribution. The generator 608 can be a temporal model generator. In addition to generating static frames, the synthetic video generator 600 can also generate short video clips conditioned to the input 602A-602N. From the input 602A-602N, an encoder 604 can generate a feature representation into shared feature space 606 that contains the information for representing the expected generated video. The feature can be inputted to the temporal model generator which creates a synthetic video 614. The temporal model generator can be in the form of a convolutional neural network, transformers, long-short term memory (LSTM), convolutional LSTM, temporal convolutional network, etc. The discriminator 610 aims at distinguishing between real and synthetic videos. Video clip synthesis can be conditioned to a temporal series of labels (e.g., semantic segmentation masks). This can result in producing time-consistent surgical videos to train temporal ML models. As a further option, a video sequence can be generated from an input image and label set pairing.

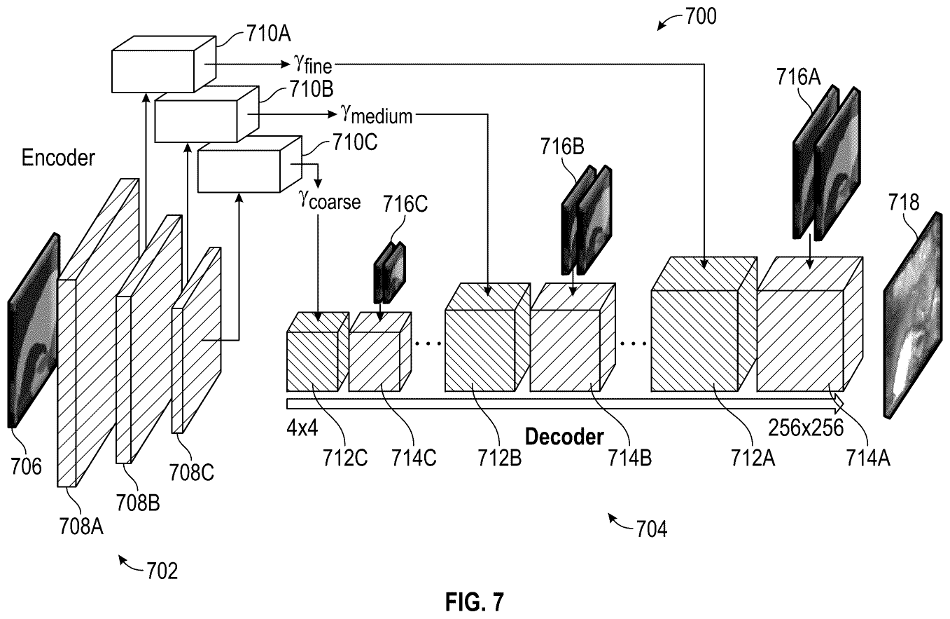

FIG. 7 depicts a block diagram of a synthetic image generator 700 according to one or more aspects. The synthetic image generator 700 is an example of a SuGAN generator architecture. Given a segmentation map 706 as input, an encoder 702 can embed the information into a latent representation γ. A decoder 704, can be composed of channel-level normalization blocks 712 and pixel-level normalization blocks 714 to enable image synthesis leveraging both latent representations as well as segmentation maps. SuGAN is a type of Generative Adversarial Network (GAN). In GANs, a generator and a discriminator compete with each other on antagonistic tasks, one to generate data that cannot be distinguished from real ones, and the other to tell synthetic and real data apart. Among them, one example is a StyleGAN that represents a framework with the ability to produce realistic high-resolution images. StyleGAN can be configured to support multi-modal image generation, where the appearance, colors, and luminance of the objects in the image can be modified while leaving semantics unaltered. Other architectures besides GANs include variational autoencoders (VAE) and diffusion models, although these approaches may be unconditional. In contrast, a conditional-GAN (cGAN) can use a conditional approach where synthetic and real images are used by the discriminator along with their condition to learn a joint annotation-image mapping. Based on cGANs, SPatially Adaptive Denormalization (SPADE) and Only Adversarial Semantic Image Synthesis (OASIS) can perform conditional image synthesis, where segmentation maps are encoded as normalization parameters at different levels in the network to serve a base for feature translation. Compared to unconditional models, cGAN based models may produce images of limited quality. This may be intrinsic to model formulation, where models focus on translating visual features according to the annotation, rather than evaluating the image at a global scale. In a similar direction, CollageGAN can employ pre-trained, class-specific StyleGAN models to improve the generation of finer details on the synthetic images. Other approaches can use a learnable encoder jointly with a frozen pre-trained StyleGAN to learn latent space mappings from segmentation maps. However, the quality of these models is bounded to StyleGAN capability to fully cover the training distribution.

The synthetic image generator 700 of FIG. 7 can be formed in consideration of multiple goals. As one example, let x∈{0, 255}^{W,H,3} be an RGB image with width W, height H, and 3 color channels, and let y∈{0,C−1}^{W,H} be a pixel-wise segmentation map with C different semantic classes. Let G(·):y→xₛ be a GAN that, given as input a segmentation map y, generates a synthetic image, xₛ~X, where X is the distribution of real images. One goal is to design G(·) so that it can generate realistic multi-modal images conditioned to an input annotation y. This directly translates to the problem of preserving the image content while varying the style, where content refers to semantic features in the image, namely objects' shape and location, while style relates to the appearance of the object such as colors, texture, and luminance.

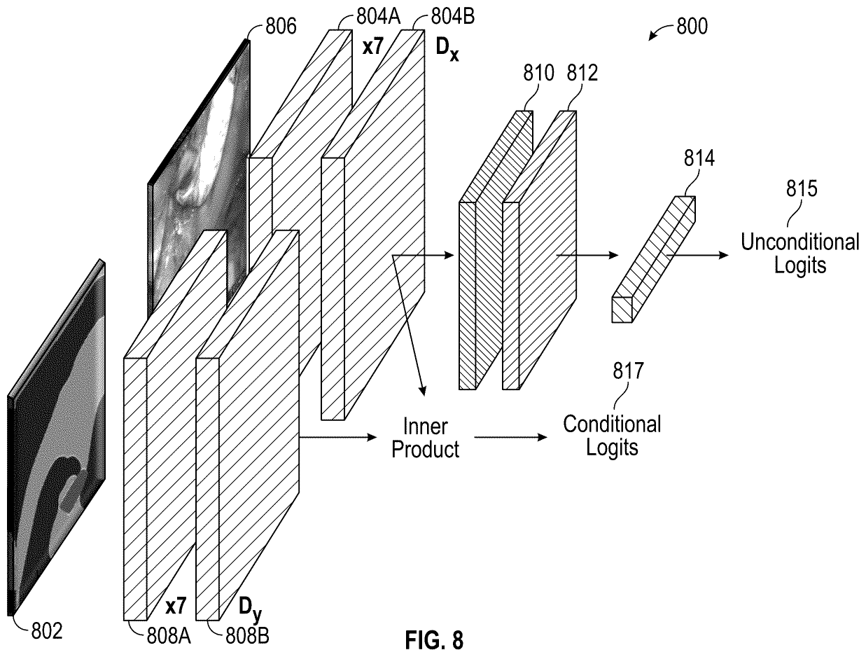

According to an aspect, SuGAN is an example of an adversarially trained model that can produce novel, realistic, and diverse images conditioned to semantic segmentation maps. An encoder-decoder-discriminator structure is used, where the task of the encoder 702 is to extract the essential information from the input segmentation map 706 while the decoder 704 generates synthetic images 718 from the input segmentation maps 706 and the output of the encoder 702. Finally, a discriminator 800 of FIG. 8 determines whether generated synthetic images 718 are real or synthetic for adversarial training. The synthetic image generator 700 can include encoders 702 for conditional image generation. An encoder E(·), can be expressed according to equation 1 as:

$$E ( \cdot ) : y \to γ , \qquad ( 1 )$$

to project segmentation maps annotations y into a latent feature γ∈R^{M×512} where M is the number of feature vectors. The encoder can use a map y that is first processed into three consecutive residual blocks 708A, 708B, 708C and the output of each block 708 is further refined by E2Style efficient heads 710A, 710B, 710C, which can include an average pooling layer followed by a dense layer, to obtain γ. As such, γ is composed of three sets of latent vectors, each one produced by a different head and controlling a different set of features in the final synthetic image, namely coarse (γ_{coarse}), medium (γ_{medium}), and fine features (γ_{fine}).

The decoder 704 of the synthetic image generator 700 can support image generation conditioned to segmentation maps 716. The decoder architecture D(·) is defined according to equation 2 as:

$$D ( \cdot ) : ( γ , y ) \to {x}_{s} , \qquad ( 2 )$$

and takes γ and y as inputs to generate the synthetic image xₛ. Decoder D can be built by sequentially nesting two blocks of normalization layers: the first can be a pixel-level normalization block 714, where a normalization parameter (mean and standard deviation) for each feature pixel is computed by processing the input segmentation map with 3×3 convolutional layers and then used to modulate sets of features at different depths in the model. The second block can be a channel-level normalization block 712 composed of two sets of 3×3 convolutional layers with weights that are modulated using two 512 latent vectors from the encoder 702 as input. In this setting, each filter in the 3×3 convolution can be first modulated to have variance equal to 1 and then demodulated by multiplying it by one element in the latent vector. For this reason, all layers inside a channel-level normalization block can have 512 channels. This can provide separability and manipulability of content and style features in the synthetic image using to channel-level normalization while allowing for precise matching of the generated image with the input segmentation map via pixel-level normalization layers.

In the example of FIG. 7, segmentation maps 716A can be a time sequence of the segmentation map 706 at a first scale, segmentation maps 716B can be a time sequence of the segmentation map 706 at a second scale, and segmentation maps 716C can be a time sequence of the segmentation map 706 at a third scale, where the second scale is less than the first scale and greater than the third scale (e.g., 4×4, 16×16, 256×256, etc.). Channel-level normalization block 712A can receive input from head 710A, channel-level normalization block 712B can receive input from head 710B, and channel-level normalization block 712C can receive input from head 710C. Pixel-level normalization block 714A can operate on segmentation maps 716A, pixel-level normalization block 714B can operate on segmentation maps 716B, and pixel-level normalization block 714C can operate on segmentation maps 716C. The scales are provided as examples and various resolutions can be used depending on the desired image or video resolution beyond those specifically noted in this example.

FIG. 8 depicts a block diagram of a discriminator 800 architecture according to one or more aspects. The discriminator 800 architecture is an example of a projection discriminator to support adversarial training. The discriminator 800 can include two feature extractors Dₓ and D_{y} (also referred to as discriminator modules) defined as

$$\begin{matrix}{D}_{x} ( \cdot ) : x \to {d}_{x} , & ( 3 ) \\ and & \\ {D}_{y} ( \cdot ) : y \to {d}_{y} , & ( 4 )\end{matrix}$$

where dₓ, d_{y}∈R^{512×4×4} are features respectively extracted from (synthetic or real) images x (image input 806), and segmentation map y (segmentation map 802). The architecture of each discriminator module can include several residual blocks 804A and 804B for Dₓ in series and residual blocks 808A and 808B for D_{y} in series. The extracted features dₓ and d_{y} can be used to determine whether x is real or synthetic and whether the image satisfies the segmentation condition or not. To determine whether the input image 806 is real or synthetic, the unconditional logits pₓ (e.g., unconditional logits 815) can be computed as

$${p}_{x} = α ( x ) , \qquad ( 5 )$$

where α(·) is a mini-batch standard deviation layer 810 followed by a convolutional layer 812 and dense layers 814. To determine whether the input image 806 follows segmentation map 802, the conditional logits p_{x,y} (e.g., conditional logits 817) can be computed as

$${p}_{x , y} = ( {d}_{x} , {d}_{y} 〉 , \qquad ( 6 )$$

where <·, ·> is an inner product operator.

In aspects, conditional adversarial loss can be the main objective function for training. The generator 700 and discriminator 800 can be trained on antagonistic losses defined as:

$$\begin{matrix}\begin{matrix}{L ( G , D , {x}_{s} , y )}_{Gen} = 𝒮 ( - {p}_{{x}_{s}} ) + \\ = 𝒮 ( - {p}_{{x}_{s} , y} )\end{matrix} & ( 7 ) \\ \begin{matrix}{L ( G , D , {x}_{r} , y )}_{Disc} = 𝒮 ( {p}_{{x}_{s}} ) + \\ = 𝒮 ( {p}_{{x}_{s}} , y ) + \\ = 𝒮 ( - {p}_{{x}_{r}} ) + \\ = 𝒮 ( - {p}_{{x}_{r}} , y )\end{matrix} & ( 8 )\end{matrix}$$

where xₛ and xᵣ refer to synthetic and real images respectively, and S is the softplus function defined as

$$S ( a ) = log ( 1 + {e}^{a} ) , \qquad ( 9 )$$

where a is the input logits to the function. Along the adversarial loss, lazy R1 regularization objective can be used, as

$${L}_{R 1} = ‖ W ‖ \qquad ( 10 )$$

where W are the model weights. L_{Gen} and L_{Disc} can be computed and applied in an alternative fashion for the generator and the discriminator.

According to an aspect, pixel-level normalization blocks 714 can be embedded between channel-level normalization blocks 712 to inject semantic maps directly into the model at different depths. Using this approach, SuGAN can control content features via pixel-level normalization layers while supporting multi-modal image generation by manipulating latent vectors at an inference stage.

In aspects, channel-level normalization blocks 712 can support multi-modal image generation via latent space manipulation, giving the capability of generating images with different styles while maintaining unaltered the content defined by the input segmentation map 706. To produce multi-modal images, a style randomization procedure can be used. Once the model is trained, segmentation maps can be encoded from the training dataset into latent space representation and M multivariate Gaussian distributions can be fit over each component respectively, where M=14 as one example of the SuGAN configuration. Given an input segmentation map y, encoding into the latent space γ=E(y) can be performed, and the last m∈[0, 13] components can be substituted by sampling from the multivariate distributions: γ→γ\dot{ }. A synthetic image xₛ=D(γ\dot{ }, y) can be produced, such as synthetic image 718. Sampling multiple times from the multivariate distribution can generate different γ\dot{ }, and thus multiple modalities while leaving the content unchanged.

One approach for performance validation is to use a combination of datasets to compare the SuGAN configuration with other models, such as SPADE and OASIS. Example datasets can include CholecSeg8k (LC), Robotic Partial Nephrectomy (PN), and Robotic Prostatectomy (RP). LC is a public dataset of laparoscopic cholecystectomy surgeries focusing on the resection of the gallbladder. The dataset is composed of about 8,080 frames (17 videos) from the widely used Cholec80 dataset. LC provides pixel-wise segmentation annotations of about 13 classes, including background, ten anatomical classes, and two surgical instruments. PN is a dataset of robotic partial nephrectomy surgeries focusing on the resection of the kidney. The dataset is composed of about 52,205 frames from 137 videos. PN provides pixel-wise segmentation annotations of five anatomical classes and a background class which also includes surgical instruments. RP is a dataset of robotic prostatectomy surgeries for the resection of the prostate. The dataset is composed of about 194,393 frames from 1,801 videos. RP provides pixel-wise segmentation annotations of 10 anatomical classes and a background class which does not include any surgical instrument. Table 1 shows further dataset statistics.

TABLE 1

| | # videos | | | | # frames | | | | |
|---|---|---|---|---|---|---|---|---|---|
| Dataset | Train | Val | Test | Total | Train | Val | Test | Total | # classes |
| LC | 14 | — | 3 | 17 | 7,360 | — | 720 | 8,080 | 13 |
| PN | 115 | 9 | 13 | 137 | 43,795 | 2,954 | 5,456 | 52,205 | 6 |
| RP | 1549 | 85 | 167 | 1801 | 166,152 | 10,194 | 18,047 | 194,393 | 11 |

In PN and RP datasets the generation of surgical images of anatomical structures can be targeted, and the presence of surgical instruments can be disregarded as instrument annotations are not provided. For LC, generation of anatomical structures as well as surgical instruments can be performed as instrument annotations are provided.

Performance measures of the model can be observed for two tasks. Images can be evaluated for quality and diversity of synthetic images using a variation of Fréchet Inception Distance (FID). This metric is widely used for assessing image quality and diversity of synthetic images as it captures the similarity between synthetic and real data at a dataset level in terms of distribution. Notably, FID infinite can be used as a less biased metric. Performance of segmentation models can be evaluated per each class and image using Intersection over Union (IoU)

$${IoU}_{c}^{i} = \frac{{\tilde{y}}_{c}^{i} ⋂ {y}_{c}^{i}}{{\tilde{y}}_{c}^{i} ⋃ {y}_{c}^{i}} ,$$

where

$${y}_{c}^{i}$$

is the annotated segmentation map and

$${\tilde{y}}_{c}^{i}$$

is the segmentation map predicted by the model for class c on image i. Per-class IoU is computed by averaging across images as

$${IoU}_{c} = \frac{1}{N} {\sum }_{i = 1}^{N} {IoU}_{c}^{i}$$

where N is the total number of images. In addition, mean Intersection over Union (mIoU) aggregates scores across classes and reports a single performance value, calculated as

$$mIoU = \frac{1}{C} {\sum }_{c = 1}^{C} {IoU}_{c}$$

where C is the total number of classes in the dataset.

For SuGAN, an optimization algorithm such as Adam (e.g., using adaptive moment estimation) can be used as an optimizer with a learning of 0.0025 rate and training for up to 50 epochs, for example. The batch size can be 16. Experiments can be performed with images at 256×256 resolution, but other resolutions can be supported (e.g., 512×512). As augmentation, vertical and horizontal flips as well as 90° rotations can be used in order to not introduce black edges artifacts in the synthetic images. Non-leaking augmentations can be used to stabilize training. A class-balanced sampler can be used. In the definition of a latent space, settings can include γ_{coarse}=γ₀₋₆, γ_{medium}=77-10 and γ_{fine}=711-14. The indexes can group latent space. The SPADE and OASIS examples can be trained with default settings. SPADE can be trained along with a VAE to support multimodal generation, following a variant of its original formulation. Once SuGAN is trained, synthetic images can be generated, for instance with m=5 for PN and RP and m=10 for LC. The number of components can be chosen as a trade-off between style randomization and reduction of artifacts arising from content modification. Regarding the implementation details for segmentation tasks, the models can be trained for 25 epochs using AdamW optimizer, with a OneCycle scheduler that reaches the maximum learning rate of 0.0005 after 1.25 epochs, as an example. Inference can be run using models at the last epoch for all experiments.

To enable a fair comparison between models trained with real data only and real and synthetic data, all trainings can use the same number of images in each batch, epoch, and full training. Specifically, the batch size can be set to 32, with all images being real when training with only-real images, and half of the images being real and the other half synthetic, when using both types of images. The same augmenter can be used for all experiments, with images being resized to 256×256 resolution, maintaining the aspect ratio, performing random rotations between-20 and 20 degrees, applying 25% of the times motion blur, and modifying the hue and saturation by a random value between −10 and 10. Real images can be scaled randomly between 0.7 and 2.0 times, while synthetic images are not scaled. For LC, a third of the training dataset can be sampled in each epoch using a random sampler, while for PN and RP 12,000 images can be sampled in each epoch with a class-balanced sampler, as an example.

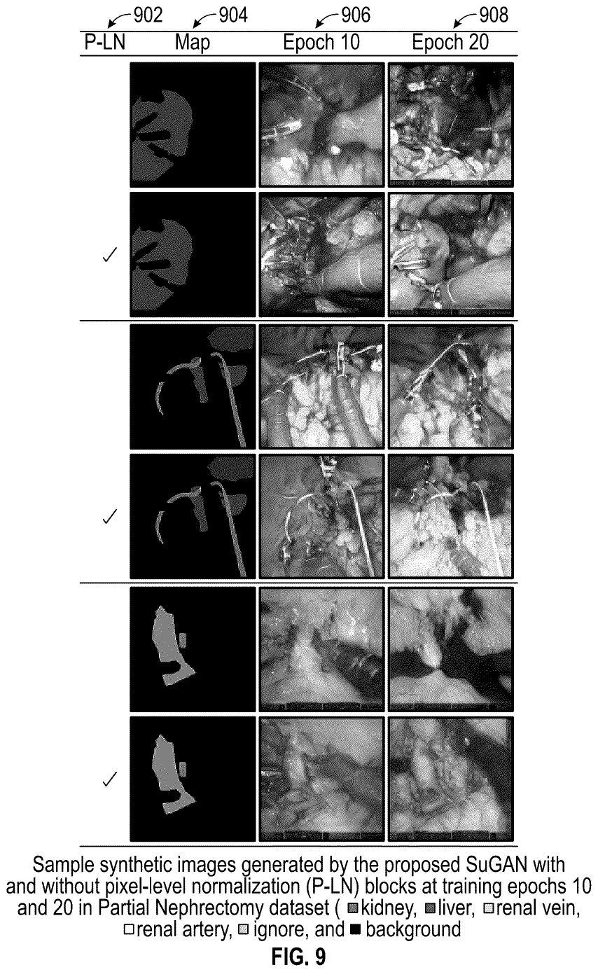

FIG. 9 depicts an example of synthetic images generated according to one or more aspects. The example of FIG. 9 illustrates the effects of using a pixel-level normalization (P-LN) 902 with an associated segmentation map 904 for SuGAN 332 to generate synthetic images trained over multiple epochs. In FIG. 9, the checkmarks indicate where P-LN 902 was used during training at 10 epochs 906 and 20 epochs 908 for a partial nephrectomy dataset. The partial nephrectomy dataset can delineate regions of the segmentation map 904 to highlight areas such as kidney, liver, renal vein, renal artery, and ignore and/or background.

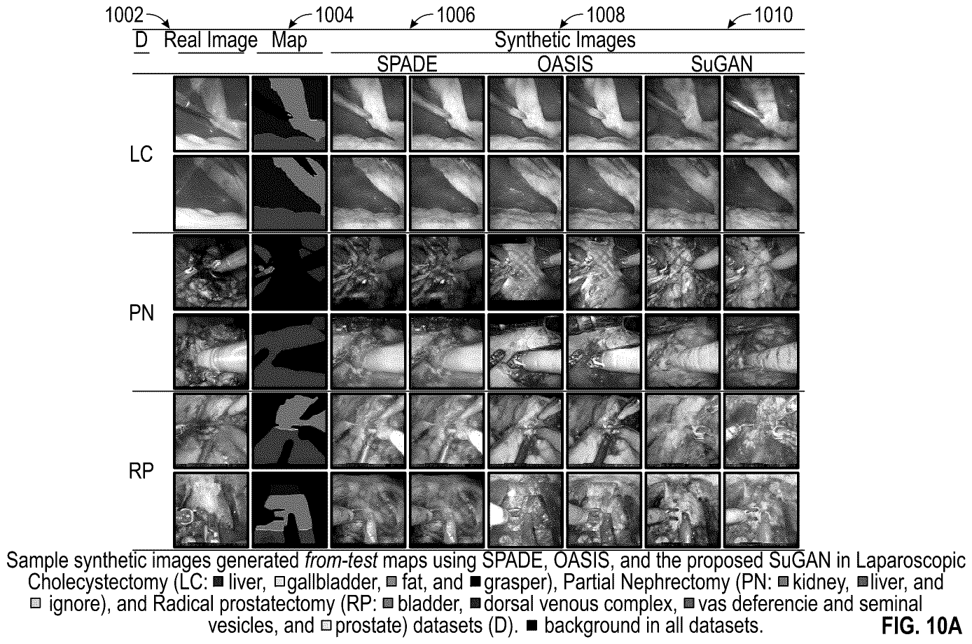

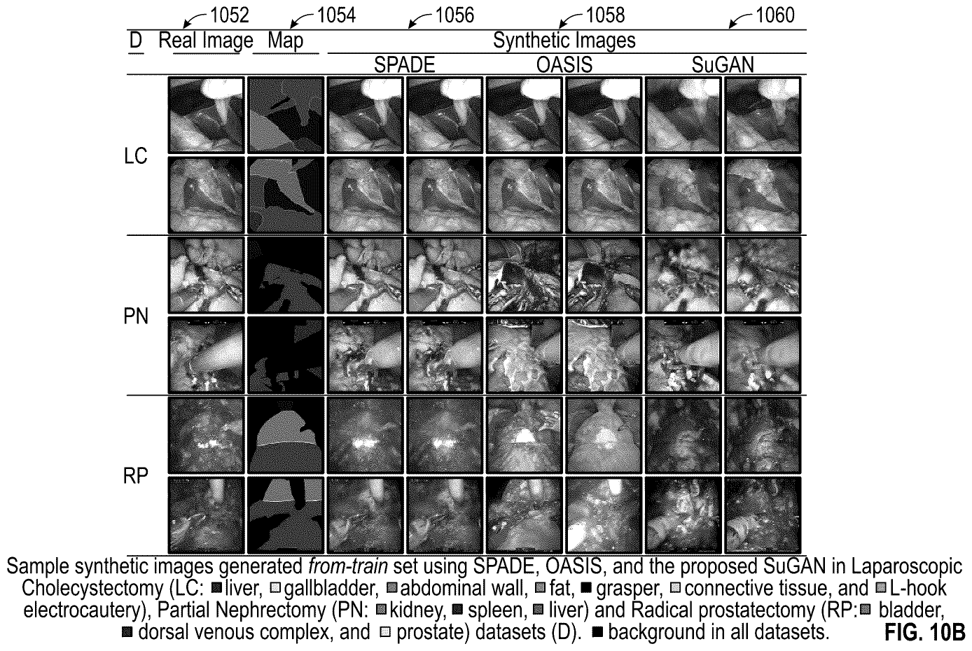

FIGS. 10A and 10B depict examples of synthetic image comparisons according to one or more aspects. Evaluation and comparison of the quality and diversity of the synthetic images generated by the SuGAN (e.g., SuGAN 332 of FIG. 3) with the ones generated by SPADE and OASIS can be performed. Once trained, two sets of synthetic images can be generated for each model and dataset, namely from-test (FIG. 10A) and from-train (FIG. 10B). A from-test set can be generated using segmentation maps not used for training of the SuGAN. A from-train set can be produced using segmentation maps from the training set as input and randomizing the style 10 times, thus creating 10 times larger training sets, for example. The datasets can be shaped in such a way to test the capabilities of the models in handling maps that were not used during training (from-test) as well as generating multi-modal diverse images (from-train). FIG. 10A depicts real images 1002, segmentation maps 1004, SPADE synthetic images 1006, OASIS synthetic images 1008, and SuGAN synthetic images 1010 generated using from-test maps based on LC, PN, and RP data sets. FIG. 10B depicts real images 1052, segmentation maps 1054, SPADE synthetic images 1056, OASIS synthetic images 1058, and SuGAN synthetic images 1060 generated using from-train maps based on LC, PN, and RP data sets.

In Table 2, the FID obtained comparing from-test images from SPADE, OASIS and SuGAN to real ones is illustrated. The lower the FID, the more similar the synthetic data distribution is to the real one, thus indicating an overall good performance and generalization ability of the generative model. The absolute value of FID is dataset-dependent, thus the FID can be compared within the same dataset, while inter-dataset FID comparison may not be meaningful.

In Table 2, the FID is illustrated when using seen and unseen maps as input.

TABLE 2

| Dataset | SPADE | OASIS | SuGAN |
|---|---|---|---|
| LC | 137.99 | 115.08 | 107.70 |
| PN | 34.33 | 27.10 | 28.38 |
| RP | 22.35 | 11.87 | 8.03 |

In FIG. 10A, both SuGAN and OASIS models manage to produce original multi-modal images, while SPADE appears constrained to mono-modal generation. Regarding an LC dataset, SPADE and OASIS appeared to obtain the worst FID, 137.99 and 115.08, respectively, while SuGAN can achieve an FID of 107.70, for instance. This may indicate a performance advantage of SuGAN in terms of image quality and diversity, as it can be appreciated in FIG. 10A (1^{st} and 2^{nd} rows), where SuGAN is the only model that may generate diverse images on LC when using from-test input maps. Regarding a PN dataset, OASIS, may obtain a favorable FID, indicating a better generalization capability compared to SPADE. OASIS, however, may generate cartoon-like instance blending within images (e.g., FIG. 10A, 3^{rd} and 4^{th} rows). This is not the case with SuGAN, with a discriminator that appears to discard such images from the synthetic image distribution. SPADE may obtain the worst FID in the same dataset and show mono-modal images, and thus may result in reduced quality generation capabilities compared to SuGAN and OASIS. Further, on an RP dataset, SuGAN can lead with a score of 8.03, followed by OASIS (11.87) and SPADE (22.35). In aspects, possibly due to the large size of the dataset, some models can show the ability to produce images dissimilar to the training images, although with different levels of diversity, and still reflecting issues described above for OASIS and SPADE.

When generating images from from-train maps, which were used to train segmentation models in other experiments, an implementation of SPADE may be unable to generate images with different styles in datasets while usually producing images similar in distribution to the real ones. OASIS may generate diverse images in both PN and RP datasets; however, the images can contain cartoonlike artifacts, as may be seen in OASIS images 1058 in FIG. 10B. A potential cause the artifacts can be related to the local approach of the OASIS discriminator, which may not allow for an evaluation of an image at a global scale, thus accepting as real images those that appear as an unnatural mosaic of different image parts. OASIS can also show an inability to generate diverse samples on LC, which may be due to the small size of the dataset. Notably, SuGAN can produce diverse, realistic, and artefact-free images in all datasets, including the small LC at SuGAN images 1060.

Training segmentation models with synthetic images, together with real images, can boost segmentation performance when evaluated on test real images. Two different approaches can be used for synthetic images(S) along with real images (R), namely S>R and SR. S>R (i.e., synthetic>real) with synthetic images to pre-train the segmentation model and then fine-tuned with real images. SR (i.e., synthetic and real) can use synthetic and real images simultaneously. An example experiment can be performed in PN dataset. In the middle section of Table 3, results indicate that synthetic data can successfully be used to improve segmentation performance with either approach. S>R seems to favor transformer-based architectures, while SR rewards more convolutional-based models. Overall, the use of synthetic data can show improved average performances with both approaches. SR can be used in experiments as this approach provides, on average, the most consistent and higher improvements and requires only one training stage instead of two. The same experiment can be performed on all datasets. Results in Table 3 show that using synthetic images generated with SuGAN along with real ones improves the segmentation performance of all architectures for all datasets.

TABLE 3

| | | | mIoU | mIoU | Diff |
|---|---|---|---|---|---|
| Dataset | Model | Source | Mean | Std | (%) |
| LC | DeepLab | R | 0.7887 | 0.0150 | — |
| | DeepLab | SR (RM) | 0.8016 | 0.0226 | 1.64 |
| | HRNet32 | R | 0.7928 | 0.0205 | — |
| | HRNet32 | SR (RM) | 0.8358 | 0.0080 | 5.42 |
| | HRNet48 | R | 0.7800 | 0.0370 | — |
| | HRNet48 | SR (RM) | 0.8263 | 0.0139 | 5.94 |
| | Swin-Small | R | 0.8321 | 0.0094 | — |
| | Swin-Small | SR (RM) | 0.8537 | 0.0050 | 2.60 |
| | Swin-Base | R | 0.8283 | 0.0096 | — |
| | Swin-Base | SR (RM) | 0.8450 | 0.0198 | 2.02 |
| PN | DeepLab | R | 0.6130 | 0.0052 | — |
| | DeepLab | S > R (RM) | 0.6190 | 0.0039 | 0.98 |
| | DeepLab | SR (RM) | 0.6270 | 0.0074 | 2.28 |
| | HRNet32 | R | 0.6238 | 0.0072 | — |
| | HRNet32 | S > R (RM) | 0.6284 | 0.0105 | 0.74 |
| | HRNet32 | SR (RM) | 0.6447 | 0.0114 | 3.35 |
| | HRNet48 | R | 0.6257 | 0.0057 | — |
| | HRNet48 | S > R (RM) | 0.6297 | 0.0054 | 0.64 |
| | HRNet48 | SR (RM) | 0.6546 | 0.0074 | 4.61 |
| | Swin-Small | R | 0.6474 | 0.0063 | — |
| | Swin-Small | S > R (RM) | 0.6635 | 0.0042 | 2.49 |
| | Swin-Small | SR (RM) | 0.6589 | 0.0052 | 1.77 |
| | Swin-Base | R | 0.6430 | 0.0080 | — |
| | Swin-Base | S > R (RM) | 0.6561 | 0.0060 | 2.02 |
| | Swin-Base | SR (RM) | 0.6546 | 0.0074 | 1.79 |
| RP | DeepLab | R | 0.4231 | 0.0103 | — |
| | DeepLab | SR (RM) | 0.4351 | 0.0038 | 2.83 |
| | HRNet32 | R | 0.4207 | 0.0203 | — |
| | HRNet32 | SR (RM) | 0.4404 | 0.0083 | 4.67 |
| | HRNet48 | R | 0.4138 | 0.0273 | — |
| | HRNet48 | SR (RM) | 0.4445 | 0.0048 | 7.41 |
| | Swin-Small | R | 0.3713 | 0.0420 | — |
| | Swin-Small | SR (RM) | 0.4064 | 0.0345 | 9.45 |
| | Swin-Base | R | 0.3645 | 0.0247 | — |
| | Swin-Base | SR (RM) | 0.3926 | 0.0091 | 7.71 |

Regarding LC, experimental results observed the smallest segmentation performance increase was achieved by DeepLab (1.64%) and the highest by HRNet48 (5.94%). On PN, the smallest performance increase was achieved by Swin-Small (1.77%) and the highest by HRNet48 (4.61%).

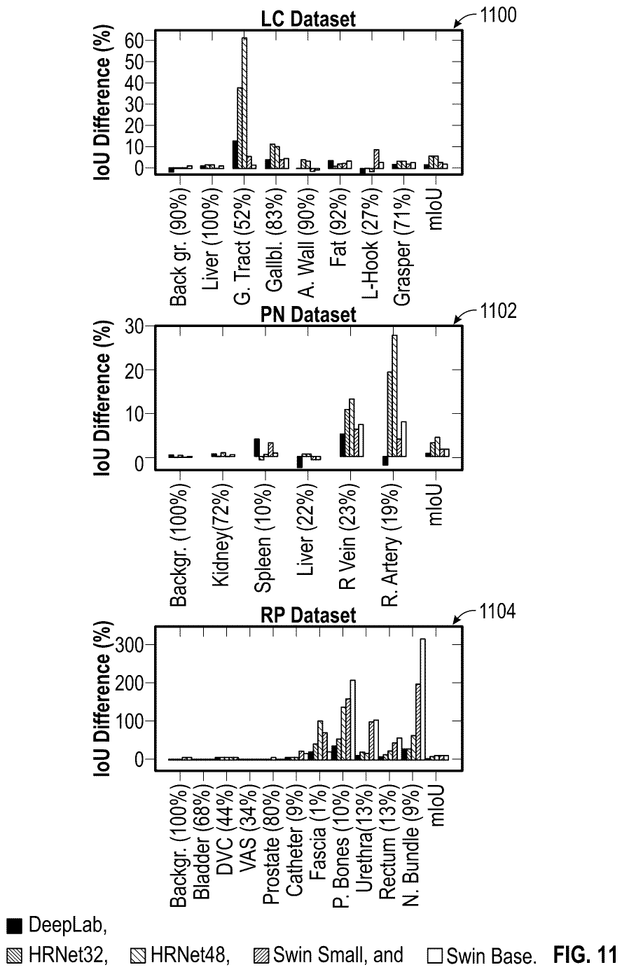

Regarding RP, finally, the smallest performance increase was achieved by DeepLab (2.83%) and the highest by Swin-Small (9.45%). The highest overall mIoU in each dataset was achieved by Swin-Small (LC), Swin-Small (PN), and HRNet48 (RP). Class-specific performance improvements are illustrated in FIG. 11. FIG. 11 depicts a example results of segmentation model performance according to one or more aspects in charts 1100, 1102, and 1104. For models and datasets, a large majority of classes improved with a small number of exceptions, where performance slightly decreased.

The largest decrease and increase in per-class performance is summarized as follows based on experimental observations. In LC, L-hook electrocautery with DeepLab decreased from 80.73 to 78.54 (2.7%), and Gastrointestinal tract with HRNet48 increased from 38.31 to 61.91 (61.6%). In PN, Liver with Swin-Small decreased from 69.06 to 68.64 (−0.6%), and Renal Artery with HRNet48 increased from 31.79 to 40.64 (27.8%). In RP, Vas deferens and seminal vesicles with Swin-Small decreased from 64.59 to 63.45 (−1.8%), and Neurovascular bundle with Swin-Base increased from 1.28 to 5.34 (316.9%).

The results may indicate a negative correlation between the amount of real data per class and the average improvement when using synthetic images, particularly in RP. This suggests that synthetic data can effectively be used to boost segmentation training in under-represented or unbalanced datasets. SR experiments can use synthetic images generated by OASIS or SPADE. This experiment was performed by training DeepLab and Swin Small on LC, PN, and LC datasets. Note that these two architectures can cover both a CNN and a transformer-based model. The results are in Table 4.

TABLE 4

mIoU (↑)

| Dataset | Source | Deeplab | Swin-Small |
|---|---|---|---|
| LC | R | 0.7887 | 0.8321 |
| | SR SPADE | 0.7694 | 0.8463 |
| | SR OASIS | 0.7799 | 0.8441 |
| | SR SuGAN | 0.8016 | 0.8537 |
| PN | R | 0.6130 | 0.6474 |
| | SR SPADE | 0.6169 | 0.6515 |
| | SR OASIS | 0.6101 | 0.6428 |
| | SR SuGAN | 0.6270 | 0.6589 |
| RP | R | 0.4484 | 0.4495 |
| | SR SPADE | 0.4702 | 0.4761 |
| | SR OASIS | 0.4738 | 0.4787 |
| | SR SuGAN | 0.4665 | 0.4648 |

While using synthetic images generated by SPSGAN can improve mIoU, images from SPADE or OASIS may not always lead to such a positive result. Focusing on Deeplab, both SPADE and OASIS can be seen to decrease the performance in LC by up to 2.44%, while increasing by 0.63% (SPADE) and decreasing by 0.48% (OASIS) in PN. On RP dataset, with both segmentation models, SPADE can be shown to generate more suitable images to support segmentation (+9.50% compared to R), followed by OASIS (+6.69%) and SuGAN (+2.83%). This result goes against the assumption that a better FID would lead to a better segmentation performance. When training Swin Small, the results can follow the same behavior, where SuGAN outperforms SPADE and OASIS on LC and PN, while showing more limited, although positive, performances on RP. On final analysis, it appears that the images produced by SuGAN have more impact when training segmentation models on datasets of small (LC) and medium (PN) sizes, while frames from SPADE and OASIS have more significant effect on large datasets (RP).

As a further example, it may be determined whether SuGAN can produce images at double resolution (512×512). To achieve this, one more set of pixel-level and channel-level normalization blocks can be added on top of the architecture of decoder 704 of FIG. 7, and the number of latent vectors can be increased to 16 to support one more up-sampling step. The model can be trained on PN and, similarly to previous experiments, segmentation results (Deeplab) can be compared when training in R and SR configurations. It appears that using synthetic images generated from SuGAN can enhance segmentation results (Table 5).

TABLE 5

| Class | Source | mIoU Mean | mIoU Std | Diff (%) |
|---|---|---|---|---|
| Background | R | 0.9111 | 0.0018 | — |
| | SR | 0.9132 | 0.0019 | 0.24 |
| Kidney | R | 0.7460 | 0.0061 | — |
| | SR | 0.7559 | 0.0075 | 1.33 |
| Spleen | R | 0.5838 | 0.0144 | — |
| | SR | 0.5760 | 0.0236 | −1.34 |
| Liver | R | 0.6946 | 0.0110 | — |
| | SR | 0.7027 | 0.0095 | 1.16 |
| Renal vein | R | 0.4391 | 0.0193 | — |
| | SR | 0.5155 | 0.0231 | 17.38 |
| Renal artery | R | 0.3537 | 0.0162 | — |
| | SR | 0.3553 | 0.0072 | 0.45 |
| mIoU | R | 0.6214 | 0.0061 | — |
| | SR | 0.6364 | 0.0084 | 2.42 |

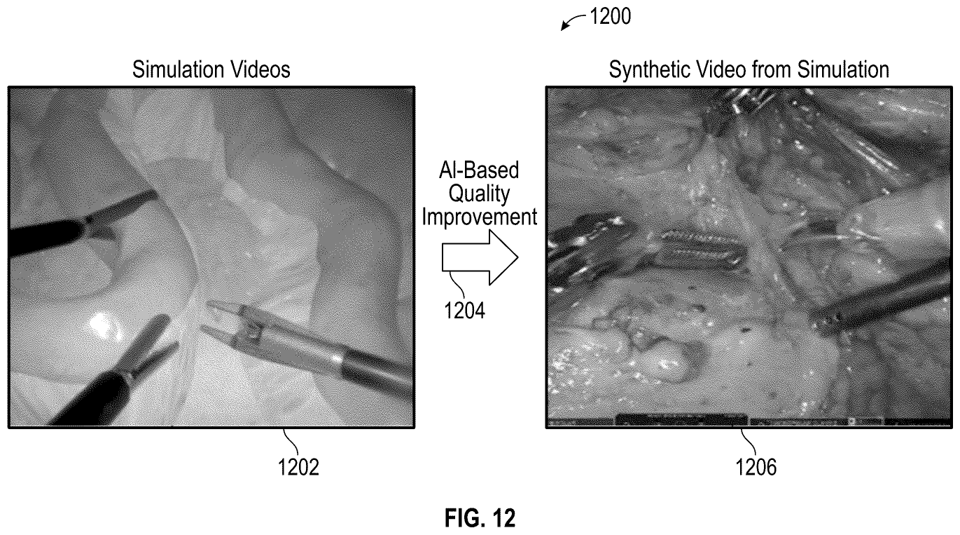

FIG. 12 depicts an example of synthetic video generation 1200 applied to a simulation video according to one or more aspects. The example of FIG. 12 illustrates that an artificial intelligence based quality improvement 1204 can enhance simulation videos 1202 of a simulation environment to appear more realistic using synthetic video generation, such as SuGAN 332 of FIG. 3, to generate a synthetic video 1206 from a simulation.

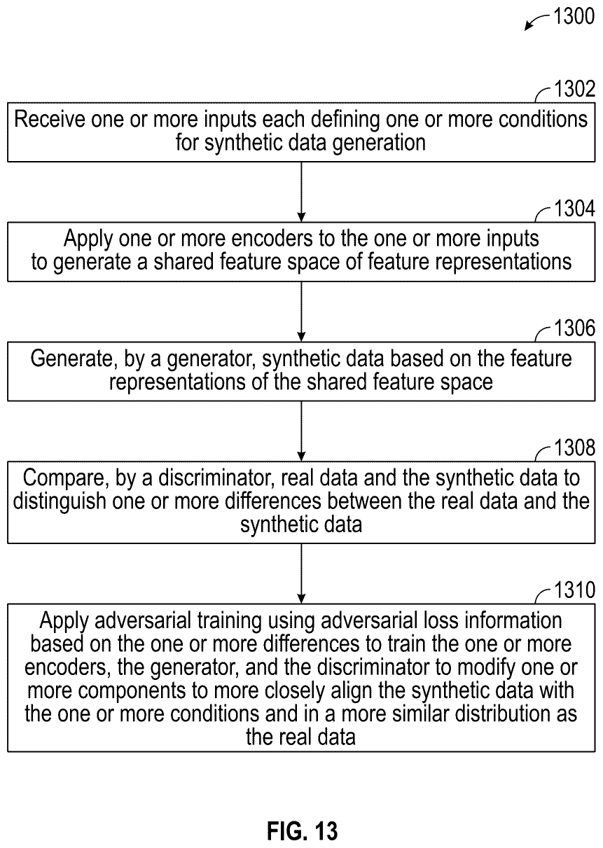

FIG. 13 depicts a flowchart of a method of synthetic data generation according to one or more aspects. The method 1300 can be executed by a system, such as system 300 of FIG. 3 as a computer-implemented method. For example, the method 1300 can be implemented by the machine learning training system 325 and/or data generator 315 performed by a processing system, such as processing system 1400 of FIG. 14.

At block 1302, one or more inputs can be received each defining one or more conditions for synthetic data generation. At block 1304, one or more encoders can be applied to the one or more inputs to generate a shared feature space of feature representations. At block 1306, a generator can generate synthetic data based on the feature representations of the shared feature space. At block 1308, a discriminator can compare real data and the synthetic data to distinguish one or more differences between the real data and the synthetic data. At block 1310, adversarial training using adversarial loss information can be applied based on the one or more differences to train the one or more encoders, the generator, and the discriminator to modify one or more components to more closely align the synthetic data with the one or more conditions and in a more similar distribution as the real data. Modifications can include adjusting weights within the encoders and/or generators as the one or more components, for example.

According to some aspects, the synthetic data can include a synthetic surgical image.

According to some aspects, the synthetic data can include synthetic surgical video.

According to some aspects, the generator can be a temporal model generator that creates the synthetic surgical video.

According to some aspects, the one or more inputs can include a text description of one or more of: anatomy, a surgical instrument, and a surgical phase.

According to some aspects, the one or more inputs can include one or more bounding boxes and key points with labels.

According to some aspects, the one or more inputs can include one or more sketches with labels.

According to some aspects, the one or more inputs can include one or more segmentation regions with labels.

According to some aspects, the one or more inputs can include one or more surgical phases.

According to some aspects, the one or more inputs can include a temporal series of labels.

According to some aspects, the one or more inputs can include an input image paired with one or more labels.

According to some aspects, the synthetic data can be added to a data store, and one or more machine learning models can be trained using the synthetic data from the data store.

According to some aspects, the synthetic data can include one or more annotations.

According to some aspects, the feature representations can include a condition mask, and the generator can be configured to preserve content and modify a style based on a user-defined preference.

According to some aspects, the user-defined preference can define one or more of a degree of blood present, a degree of fatty tissue present, or other tissue variation.

According to some aspects, the generator can be configured to preserve a style and modify content in the synthetic data.

According to some aspects, the synthetic data can be generated based on an image or video of a simulation environment.

According to some aspects, one or more of the feature representations of the shared feature space can include random variations.

According to some aspects, the random variations can include content randomization.

According to some aspects, the random variations can include style randomization.

According to some aspects, a system can include a data store including video data associated with a surgical procedure. The system can also include a machine learning training system configured to train a generative adversarial network model to generate synthetic surgical data, combine the synthetic surgical data with real surgical data to form an enhanced training data set in the data store, and train one or more machine learning models using the enhanced training data set.

According to some aspects, the generative adversarial network model can include an encoder that projects a plurality of segmentation maps into latent features and a decoder including sequentially nested blocks of normalization layers including at least one pixel-level normalization block and at least one channel-level normalization block.

According to some aspects, a discriminator can be configured to perform adversarial training using a first feature extractor of image data and a second feature extractor of the segmentation maps.

According to some aspects, a computer program product can include a memory device having computer executable instructions stored thereon, which when executed by one or more processors cause the one or more processors to perform a plurality of operations. The operations can include applying one or more encoders to one or more inputs associated with surgical data to generate a shared feature space of feature representations and generating, by a generator, synthetic data based on the feature representations of the shared feature space, where the generator includes a decoder with sequentially nested blocks of normalization layers including at least one pixel-level normalization block and at least one channel-level normalization block.

According to some aspects, the at least one pixel-level normalization block can compute a normalization parameter for each feature pixel based on an input segmentation map, and the at least one channel-level normalization block can include at least two convolutional layers with weight modulated using a plurality of vectors from the one or more encoders.

Aspects as disclosed herein can take one or multiple user input modalities to generate synthetic data. Synthetic data generation can use visual data for generating conditional synthetic images that include both surgical instruments and anatomical structures without the need for a 3D simulator or real anatomical background images.

It is understood that one or more aspects is capable of being implemented in conjunction with any other type of computing environment now known or later developed. For example, FIG. 14 depicts a block diagram of a processing system 1400 for implementing the techniques described herein. In examples, processing system 1400 has one or more central processing units (“processors” or “processing resources” or “processing devices”) 1421a, 1421b, 1421c, etc. (collectively or generically referred to as processor(s) 1421 and/or as processing device(s)). In aspects of the present disclosure, each processor 1421 can include a reduced instruction set computer (RISC) microprocessor. Processors 1421 are coupled to system memory (e.g., random access memory (RAM) 1424) and various other components via a system bus 1433. Read only memory (ROM) 1422 is coupled to system bus 1433 and may include a basic input/output system (BIOS), which controls certain basic functions of processing system 1400.

Further depicted are an input/output (I/O) adapter 1427 and a network adapter 1426 coupled to system bus 1433. I/O adapter 1427 may be a small computer system interface (SCSI) adapter that communicates with a hard disk 1423 and/or a storage device 1425 or any other similar component. I/O adapter 1427, hard disk 1423, and storage device 1425 are collectively referred to herein as mass storage 1434. Operating system 1440 for execution on processing system 1400 may be stored in mass storage 1434. The network adapter 1426 interconnects system bus 1433 with an outside network 1436 enabling processing system 1400 to communicate with other such systems.

A display 1435 (e.g., a display monitor) is connected to system bus 1433 by display adapter 1432, which may include a graphics adapter to improve the performance of graphics intensive applications and a video controller. In one aspect of the present disclosure, adapters 1426, 1427, and/or 1432 may be connected to one or more I/O busses that are connected to system bus 1433 via an intermediate bus bridge (not shown). Suitable I/O buses for connecting peripheral devices, such as hard disk controllers, network adapters, and graphics adapters typically include common protocols, such as the Peripheral Component Interconnect (PCI). Additional input/output devices are shown as connected to system bus 1433 via user interface adapter 1428 and display adapter 1432. A keyboard 1429, mouse 1430, and speaker 1431 may be interconnected to system bus 1433 via user interface adapter 1428, which may include, for example, a Super I/O chip integrating multiple device adapters into a single integrated circuit.

In some aspects of the present disclosure, processing system 1400 includes a graphics processing unit 1437. Graphics processing unit 1437 is a specialized electronic circuit designed to manipulate and alter memory to accelerate the creation of images in a frame buffer intended for output to a display. In general, graphics processing unit 1437 is very efficient at manipulating computer graphics and image processing, and has a highly parallel structure that makes it more effective than general-purpose CPUs for algorithms where processing of large blocks of data is done in parallel.

Thus, as configured herein, processing system 1400 includes processing capability in the form of processors 1421, storage capability including system memory (e.g., RAM 1424), and mass storage 1434, input means, such as keyboard 1429 and mouse 1430, and output capability including speaker 1431 and display 1435. In some aspects of the present disclosure, a portion of system memory (e.g., RAM 1424) and mass storage 1434 collectively store the operating system 1440 to coordinate the functions of the various components shown in processing system 1400.

It is to be understood that the block diagram of FIG. 14 is not intended to indicate that the computer system 1400 is to include all of the components shown in FIG. 14. Rather, the computer system 1400 can include any appropriate fewer or additional components not illustrated in FIG. 14 (e.g., additional memory components, embedded controllers, modules, additional network interfaces, etc.). Further, the aspects described herein with respect to computer system 1400 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language, such as Smalltalk, C++, high-level languages such as Python, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to aspects of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects of the present invention have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects of the invention are described herein with reference to the related drawings. Alternative aspects of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium, such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), graphics processing units (GPUs), microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A computer-implemented method comprising:
receiving one or more inputs each defining one or more conditions for synthetic data generation;
applying one or more encoders to the one or more inputs to generate a shared feature space of feature representations;
generating, by a generator, synthetic data based on the feature representations of the shared feature space;
comparing, by a discriminator, real data and the synthetic data to distinguish one or more differences between the real data and the synthetic data; and
applying adversarial training using adversarial loss information based on the one or more differences to train the one or more encoders, the generator, and the discriminator to modify one or more components to more closely align the synthetic data with the one or more conditions and in a more similar distribution as the real data.

2. The computer-implemented method of claim 1, wherein the synthetic data comprises a synthetic surgical image.

3. The computer-implemented method of claim 1, wherein the synthetic data comprises a synthetic surgical video, and the generator is a temporal model generator that creates the synthetic surgical video.

4. The computer-implemented method of claim 1, wherein the one or more inputs comprises a text description of one or more of: anatomy, a surgical instrument, and a surgical phase.

5. The computer-implemented method of claim 1, wherein the one or more inputs comprises one or more bounding boxes and key points with labels.

6. The computer-implemented method of claim 1, wherein the one or more inputs comprises wherein the one or more inputs comprises one or more sketches with labels.

7. The computer-implemented method of claim 1, wherein the one or more inputs comprises one or more segmentation regions with labels.

8. The computer-implemented method of claim 1, wherein the one or more inputs comprises one or more surgical phases.

9. The computer-implemented method of claim 1, wherein the one or more inputs comprises a temporal series of labels.

10. The computer-implemented method of claim 1, wherein the one or more inputs comprises an input image paired with one or more labels.

11. The computer-implemented method of claim 1, further comprising:
adding the synthetic data to a data store, wherein the synthetic data comprises one or more annotations; and
training one or more machine learning models using the synthetic data from the data store.

12. The computer-implemented method of claim 1, wherein the feature representations comprise a condition mask, and the generator is configured to preserve content and modify a style based on a user-defined preference, and the user-defined preference defines one or more of a degree of blood present, a degree of fatty tissue present, or other tissue variation.

13. The computer-implemented method of claim 1, wherein the generator is configured to preserve a style and modify content in the synthetic data.

14. The computer-implemented method of claim 1, wherein the synthetic data is generated based on an image or video of a simulation environment.

15. The computer-implemented method of claim 1, wherein one or more of the feature representations of the shared feature space comprise random variations, wherein the random variations comprise one or more of content randomization and style randomization.

16. A system comprising:
a data store comprising video data associated with a surgical procedure; and
a machine learning training system configured to:
train a generative adversarial network model to generate synthetic surgical data;
combine the synthetic surgical data with real surgical data to form an enhanced training data set in the data store; and
train one or more machine learning models using the enhanced training data set.

17. The system of claim 16, wherein the generative adversarial network model comprises an encoder that projects a plurality of segmentation maps into latent features and a decoder comprising sequentially nested blocks of normalization layers comprising at least one pixel-level normalization block and at least one channel-level normalization block.

18. The system of claim 16, further comprising a discriminator configured to perform adversarial training using a first feature extractor of image data and a second feature extractor of the segmentation maps.

19. A computer program product comprising a memory device having computer executable instructions stored thereon, which when executed by one or more processors cause the one or more processors to perform a plurality of operations comprising:
applying one or more encoders to one or more inputs associated with surgical data to generate a shared feature space of feature representations; and
generating, by a generator, synthetic data based on the feature representations of the shared feature space, wherein the generator comprises a decoder with sequentially nested blocks of normalization layers comprising at least one pixel-level normalization block and at least one channel-level normalization block.

20. The computer program product of claim 19, wherein the at least one pixel-level normalization block computes a normalization parameter for each feature pixel based on an input segmentation map, and the at least one channel-level normalization block comprises at least two convolutional layers with weight modulated using a plurality of vectors from the one or more encoders.
